(19) United States
(12) Patent Application Publication
(10) Pub. No.: US 2026/0092487 A1
(43) Pub. Date: Apr. 2, 2026

(54) SYSTEMS AND METHODS FOR INTELLIGENT CONTROL OF VEHICLE WINDOWS

(71) Applicant: Ford Global Technologies, LLC, Dearborn, MI (US)

(72) Inventors: Keith Weston, Canton, MI (US); John Robert Van Wiemeersch, Novi, MI (US); Brendan Diamond, Naples, FL (US)

(73) Assignee: Ford Global Technologies, LLC, Dearborn, MI (US)

(21) Appl. No.: 18/899,138

(22) Filed: Sep. 27, 2024

(51) Int. Cl. E05F 15/71; B60J 1/17; B60K 35/28; E05F 15/73

(52) U.S. Cl. CPC E05F 15/71; B60J 1/17; B60K 35/28; E05F 15/73; B60K 2360/143; E05F 2015/763; E05F 2015/767; E05Y 2400/851; E05Y 2400/858; E05Y 2900/55

(57) ABSTRACT

Systems and methods for operating a vehicle are provided. A vehicle can detect activation of a one touch window open/close feature of the vehicle. Based on that, the vehicle then detects that one or more conditions associated with the one touch window open/close feature are met. The vehicle further provides one or more options for modifying a default operation of the one touch window open/close feature. The vehicle then receives an input indicating selection of one of the one or more options and modifies the default operation of the one touch window open/close feature to determine a modified operation. Thereafter, the vehicle performs the one touch window open/close operation based on the modified operation.

### FIELD

The present disclosure relates to the field of operation of window control for vehicles. Specifically, embodiments of the present disclosure relate to intelligent operation of the one touch window open or close feature for a vehicle.

### BACKGROUND

Use of one-touch window open/close function in vehicles is ubiquitous. The one-touch window open/close feature enables, with a single press, a driver or a passenger to fully lower the window, freeing up their hands for other tasks. This is particularly useful when entering parking garages, toll booths, or drive-throughs, where quick access is useful. By allowing the user of the vehicle to lower a window with a single touch, this feature helps maintain focus on the road. It reduces the need to keep pressing the button multiple times, minimizing interruptions.

The one-touch feature adds to the overall user-friendly experience of modern vehicles, contributing to a smoother, more effortless driving experience. It's a small yet significant convenience that aligns with the broader trend of enhancing car usability and comfort.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle in accordance with one or more embodiments of the present disclosure.

FIG. 3 illustrates a flow diagram if a process for operating a vehicle in accordance with one or more embodiments of the present disclosure.

FIG. 4 illustrates example user interface screens in accordance with one or more embodiments of the present disclosure.

FIG. 5 illustrates a flow chart of a process for operating a one touch window open/close feature in accordance with one or more embodiments of the present disclosure.

FIG. 6 illustrates a flow chart of a process for operating a one touch window open/close feature in accordance with one or more embodiments of the present disclosure.

FIG. 7 depicts a block diagram of an example control server in accordance with one or more embodiments of the present disclosure.

### DETAILED DESCRIPTION

### Overview

The present disclosure describes systems and methods for modifying a default operation of a one touch window open/close feature of a vehicle based on specific conditions detected in the vicinity of the vehicle.

Embodiments of the present disclosure provide a method for operating a vehicle. The method includes detecting, by a vehicle, activation of a one touch window open/close feature of the vehicle. The method further includes detecting that one or more conditions associated with the one touch window open/close feature are met and providing, by the vehicle, one or more options for modifying a default operation of the one touch window open/close feature. The method further includes receiving an input indicating selection of one of the one or more options, modifying the default operation of the one touch window open/close feature to determine a modified operation, and performing the one touch window open/close operation based on the modified operation.

In another instance, a vehicle is provided that can detect activation of a one touch window open/close feature of the vehicle and detect that one or more conditions associated with the one touch window open/close feature are met. The vehicle further provides one or more options for modifying a default operation of the one touch window open/close feature. Thereafter, the vehicle receives an input indicating selection of one of the one or more options, modifies the default operation of the one touch window open/close feature to determine a modified operation, and performs the one touch window open/close operation based on the modified operation.

In yet another instance, a method for operating a one touch window open/close feature of a vehicle is provided. The method includes the vehicle detecting at a first time that the vehicle is at a first location. The method further includes determining one or more conditions associated with the first location and determining the status of a window of the vehicle at the first location. The method further includes generating association information related to the first location, the one or more conditions, and the status of the window. The method then includes the vehicle associating a one touch window open/close control operation with the association information.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

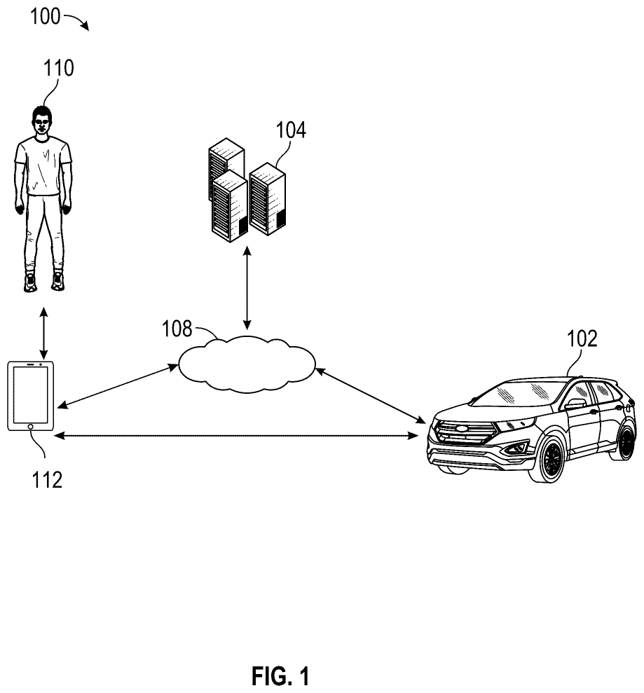

FIG. 1 illustrates an environment 100 in which the embodiments of the present disclosure may be implemented. The vehicle 102 can be any passenger or commercial vehicle such as a car, truck, tanker, bus, or the like.

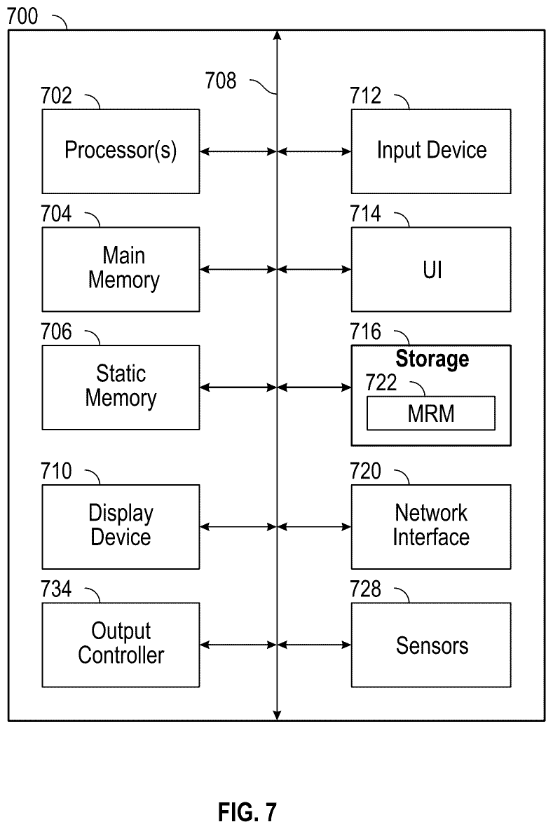

The environment 100 may also include a control server 104. The control server 104 may be part of a cloud-based computing infrastructure and may be associated with and/or include a Telematics Service Delivery Network (SDN) that provides digital data services to the vehicle 102. Details of the control server 104 are provided below with reference to FIG. 7.

The environment 100 may also include a user device 112. The user device 112 may be one of a mobile phone, a tablet, a personal computer, a smart key fob, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle generated information and other control data. In one embodiment, the vehicle 102 may directly communicate with the user device 112 to send and receive data without the need for the network 108 and/or the server 104.

The environment 100 may further include a network 108. The network 108 illustrates an example communication infrastructure in which the connected devices discussed in various embodiments of this disclosure may communicate. The network 108 may be and/or include the Internet, a private network, public network or other configuration that operates using any one or more known communication protocols such as, for example, transmission control protocol/Internet protocol (TCP/IP), Bluetooth®, Bluetooth® low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

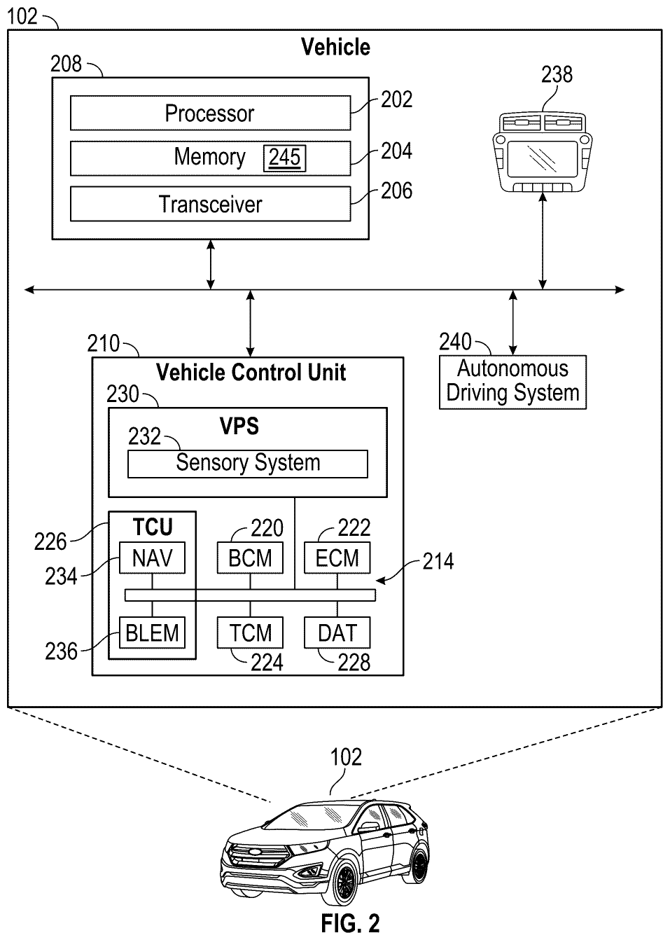

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 disposed in communication with the automotive computer 208.

In some embodiments, a user device, such as a mobile phone, a laptop computer, or the like may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be disposed in communication with one or more memory devices disposed in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc. to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power and/or communications bus with the automotive computer 208 and may be configured and/or programmed to coordinate the data between vehicle systems, connected servers and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more manner. For example, the various sensors of the vehicle sensory system 232 may be integrated into the various subsystems of the vehicle 102, such as doors, mirrors, roof, etc. or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102 while a sensor that can monitor an area to either side of the vehicle 102 may be mounted or integrated into the doors of the vehicle 102. Vehicle sensory system 232 may also include one or more road noise sensors such as accelerometers that are coupled to various mechanical components and/or systems of the vehicle 102. One skilled in the art will realize that the sensors may be coupled to the vehicles in various different ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and off board the vehicle 102, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems, and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some embodiments, the automotive computer 208 may connect with an infotainment system 238 (or a vehicle Human-Machine Interface (HMI)). The infotainment system 238 may include a touchscreen interface portion, and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion, and/or output or display notifications, navigation maps, etc. on the touchscreen interface portion.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In addition to the components noted above, the vehicle 102 may have numerous mechanical systems and sub-systems. A chassis or frame may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 also includes a transmission system. The transmission system transfers the engine's power to the wheels. It includes the clutch, gearbox, driveshaft, and differentials, among other components. The transmission adjusts the power output to suit the vehicle's speed and load. The vehicle 102 may also include a suspension system. The suspension system absorbs shocks and maintains contact between the tires and the road, providing a smooth ride. It includes components such as springs, shock absorbers, and linkages. The vehicle 102 also includes a braking system that allows the driver to slow down or stop the vehicle 102. It includes components like brake pedals, master cylinder, brake lines, and brake pads or shoes. The vehicle 102 also includes a steering system that enables the driver to guide the car. The steering system includes components such as the steering wheel, steering column, rack and pinion, and tie rods. The vehicle 102 also includes an exhaust system that removes and filters the waste gases produced by the engine. It includes the exhaust manifold, catalytic converter, muffler, and tailpipe, among other components. The vehicle 102 also includes a cooling system that prevents the engine from overheating. It includes components such as the radiator, water pump, thermostat, and coolant. The vehicle 102 also includes a cooling system that stores and supplies fuel to the engine. It includes the fuel tank, fuel pump, fuel filter, and fuel injectors. An electrical system of the vehicle 102 powers the car's electrical components. It includes the battery, alternator, starter motor, and wiring. The Heating, Ventilation, and Air Conditioning (HVAC) system regulates the temperature inside the vehicle 102. It includes the heater core, blower motor, and air conditioning compressor. In some embodiments, the vehicle may be an electric vehicle (EV) or hybrid vehicle, and in either case some of the aforementioned components would be replaced by an electric motor and battery. All of the mechanical components working together ensure that the vehicle operates optimally.

One touch window open/close feature is available on most modern vehicles. The one-touch window open/close feature in vehicles is designed for convenience, allowing you to fully lower a window with a single press of a button. To activate the one-touch open/close feature, a control input such as a window switch is pressed open/close firmly and then released immediately. This action sends a signal to the window's control module. The control module, which is part of the vehicle's electronic system, receives the signal and activates the motor that controls the window. The motor then runs continuously until the window is fully lowered or raised. This is different from the standard operation where the motor only runs as long as you hold the switch. The window may be stopped before it reaches the fully open or fully closed position by pressing the switch again, which halts the movement of the window. In this disclosure, this type of operation of the one touch window open/close feature will be referred to as the “default” operation. Any change in this default operation mode will be referred as a “modification”, “modified mode”, or “modified operation” or the like.

There may be instances when a user of the vehicle may not want the one touch window open/close feature to operate in its default mode. For example, if it is raining, deliberate or even inadvertent activation of the one touch window open/close feature will result in the window fully opening and allowing rainwater to enter the vehicle. In such circumstances, it would be beneficial to modify the operation of the one touch window open/close operation and prevent the window from opening fully. The systems and methods provided in this disclosure allow for intelligent control of the one touch window open/close operation to account for various internal and external conditions associated with the vehicle thereby further enhancing the usability of the one touch window open/close feature. Although the disclosure uses rain as an example of an external condition, it is to be noted that the techniques disclosed herein are equally applicable to any other external conditions including but not limited to snow, sleet, smoke, dust, sand, other pollutants, debris, etc.

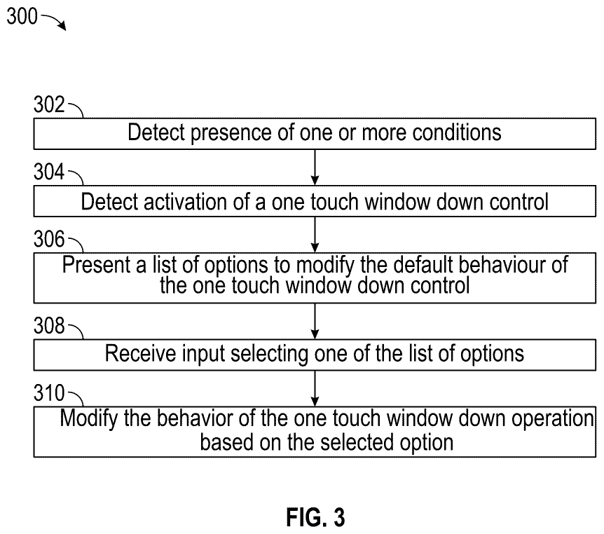

FIG. 3 illustrates a flow diagram for a method 300 of operating the one touch window open/close feature in accordance with one or more embodiments of the present disclosure. The method 300 can be performed by the vehicle 102 by itself or in conjunction with the server 104. At step 304, the vehicle may detect presence of one or more conditions either internal to the vehicle or external to the vehicle. For example, one of the conditions may be presence of rain in the vicinity of the vehicle. The type of these one or more conditions may be predetermined or may be learned based on user driving pattern and/or information gathered from external sources. At step 304, the vehicle may detect activation of a one touch window open/close control input. Continuing from our example above, since it is raining it may not be desirable to fully open the window. In other words, the default operation of the one touch window open/close feature may not be the best option under these conditions. In such a situation, the vehicle may present a list of options to the user of the vehicle that provides a modification to the default operation of the one touch window open/close feature, at step 306. For example, one of the options may be to open the window partially instead of fully to limit the amount of rain that may enter the vehicle.

At step 308, the user may select one of the options and the vehicle receives information about the option selected by the user. Thereafter, at step 310, the vehicle may operate the window based on the option selected. Thus, in this instance, even though the control input associated with the one touch window open/close feature is activated, the operation of the feature is modified, and the window is only opened partially thus preventing rainwater from entering the vehicle and providing the user of the vehicle with a better user experience.

The one or more conditions that are detected in step 302 may include one or more of environmental conditions, a specific location, a specific structure, a person, an event, a fixed or transitory object, or the like. In one embodiment, the operation of the one touch window open/close feature may be modified based on a location or based on presence of a specific structure or object at a specific location. For example, when a vehicle approaches a location such as a drive-through location such as a coffee shop or an ATM, a toll plaza, an inspection station, a border crossing, or the like, the driver of the vehicle will often need to lower the driver side window in order to conduct the associated transaction like paying the toll, collecting the beverage, etc. The one touch window open/close feature is often useful in these situations. In an embodiment, the various sensors associated with the vehicle (e.g., the sensory system 232) may detect and identify the location. For example, if the location is a border crossing, the GPS or other location sensor(s) of the vehicle may determine that the vehicle is at the border crossing location and the driver will likely need to interact with the border crossing official. In this instance, if the control associated with the one touch window open/close feature is activated, the vehicle may determine that the default operation of the one touch window open/close feature is likely desired and hence the vehicle may perform the default operation. However, if the vehicle determines, based on one or more of the vehicle's sensors that it is also raining as the vehicle approaches the border crossing location, the vehicle may determine that it may not be ideal to perform the default operation of the one touch window open/close feature and instead the vehicle may present a modified operation of the feature. For instance, the vehicle may suggest that the window may only be opened partially (e.g., 50%) such that the driver may still be able to interact with the border crossing official but reduce the amount of rainwater that may enter the vehicle. Further, the vehicle may also track its orientation when the vehicle is at a toll or other check point location in order to determine which window is to be opened at that particular location. For example, the location of the border crossing official at a check point may either be on the left side of the vehicle or the right side of the vehicle depending on the driving system at that location. (e.g., left-hand drive vs. right-hand drive). In such situations, it is beneficial to open the correct window to allow the driver to interact with the border crossing official. Therefore, the vehicle may also track and note the location of the check point with respect to the orientation or heading of the vehicle to determine which window of the vehicle needs to be opened at that particular check point.

In another embodiment, the vehicle may also determine presence of people in the vicinity of the vehicle and suggest a modification to the default operation of the one touch window open/close feature. For example, at a drive-through ATM, if the vehicle determines using one or more of the vehicle's sensors that there are people present near the ATM, the vehicle may provide an alert to the driver informing the driver of the presence of people and suggesting modification to the default operation of the one touch window open/close feature. If the driver selects one of the modified operations, the vehicle may then operate the window based on the modified operation and not the default operation of the one touch window open/close feature. Thus, the vehicle may intelligently change the behavior of the one touch window open/close operation based on certain conditions being present or met.

In a further embodiment, the one touch window open/close operation of the vehicle may be modified based on presence of unknown people in the vicinity of the vehicle. If the vehicle determines that there are unknown people in close proximity, the vehicle may proactively disable this feature or limit the amount by which the window may open if the one touch window open/close feature is activated. The vehicle and/or the server 104 may store a database of known people associated with the vehicle. For example, a user may register his/her household members and other people who the user wishes to enroll under the user's account. The vehicle and/or the server may store information about these known people, such as their photographs. In operation, one or more cameras of the vehicle may capture an image of a person that is in close proximity to the vehicle and compare that image with the images in the database of known persons. If a match is not found, the vehicle may conclude that the person in the proximity of the vehicle is an unknown person. If the one touch window open/close feature is activated while this unknown person is in the vicinity of the vehicle, the vehicle may provide an alert to the driver informing him/her of the presence of the unknown person and suggesting a modified operation of the one touch window open/close feature. In another embodiment, if the vehicle detects an unknown person approaching the vehicle, the activation of the one touch window open/close feature for any one of the windows of the vehicle may also close all open windows of the vehicle concurrently. Thus, in this instance, the one touch window open/close operation is automatically performed for all the windows of the vehicle and not just for the window for which the feature was activated. In other instances, under the above condition, even if a passenger in the back seat of the vehicle activates a window open/close control that is not a one touch window open/close, that window will perform the default one touch window open/close operation along with the rest of the windows of the vehicle. This provides enhanced security for the occupants of the vehicle. Auto open/close window control would be performed in compliance with regulations and other design standards in place for anti-pinch. In other instances, if the vehicle determines that the person approaching the vehicle or in close proximity to the vehicle is a known person, the vehicle may operate the one touch window open/close feature according to its default operation.

In other embodiments, the one touch window open/close operation can be modified based on environmental factors. For example, if the one or more sensors of the vehicle detect that it is raining and the user of the vehicle activates the one touch window open/close control input, the vehicle may provide a list of options to the user to modify the one touch window open/close operation. In one instance, the list of options may be provided on the vehicle's HMI screen and/or via the user device 112. The list of options may include an option to partially open the window (e.g., 10%, 20%, etc.) instead of opening the window fully. In other embodiments, the vehicle may determine the intensity of the rain and may suggest a preset amount of opening for the window. This suggestion may be on the HMI screen or via speech synthesis. The user's response may also be executed via speech recognition. For instance, the vehicle may include conductance sensors that can measure the electrical conductivity of water. When raindrops fall on the sensor's surface, they change the resistance between conductive traces. The more intense the rainfall, the lower the resistance, which can be translated to into rain intensity. In other embodiments, the vehicle may include optical rain sensors that use infrared light and the principle of total internal reflection. When raindrops hit the sensor's surface, they disrupt the light path, causing changes in the reflected light. The sensor measures these changes to determine the presence and intensity of the rain. In yet other embodiments, the vehicle may include capacitive sensors that measure changes in capacitance caused by the presence of water. As raindrops accumulate on the sensor, the capacitance changes, which can be used to determine the amount and intensity of rainfall. The vehicle may also include radar-based sensors that measure the size and velocity of raindrops. By analyzing the radar signals, the sensor can estimate the rainfall rate and intensity.

In yet another embodiment, the one touch window open/close operation may be modified based on the external temperature. In the event of extreme cold or hot weather, the vehicle may suggest modification to the one touch window open/close operation in order to prevent the occupants of the vehicle from exposure to the extreme temperatures. One or more sensors of the vehicle may monitor the external temperature and compare that to a threshold temperature value. If the currently measured temperature is above (or below) the threshold depending on whether it is hot or cold, the vehicle may suggest modification to the default operation of the one touch window open/close feature. In one embodiment, if the temperature inside the vehicle is above a threshold, activation of the one touch window open/close control for any window may cause all the windows of the vehicle to open allowing ventilation in the vehicle. The activation of the one touch window open/close feature in any of the instances described in this disclosure may be done by pressing a physical or virtual button, using a voice command, or using a gesture. One skilled in the art will realize that there may be other means of activating the one touch window open/close feature that are within the spirit of this disclosure.

In another embodiment, the vehicle may suggest modification to the one touch window open/close feature based on presence of specific structures or objects around the vehicle. For example, if the vehicle determines that the vehicle is at a location where the vehicle is not under a covered structure such as a garage or a canopy, it may suggest modification to the one touch window open/close feature. Consider that it is raining but the vehicle is under an awning/canopy of a drive through location. In this instance, even though it is raining the vehicle may still operate the one touch window open/close feature according to its default operation since the vehicle determines that the vehicle is under some form of protective cover and as such opening the window fully is unlikely to cause the rainwater (or other types of debris or pollutants) to enter the vehicle. In other embodiments, if it is raining and the vehicle determines, based on one or more of its sensors, that is being driven in a direction where the vehicle will be under an awning/canopy imminently, the vehicle may delay performance of the one touch window open/close operation until such time when the vehicle is under the awning/canopy. In other words, if the user activates the one touch window open/close control input in the above scenario, instead of immediately opening the associated window, the vehicle may delay the opening, (e.g., by a few seconds) until after the vehicle is positioned under the awning/canopy.

In yet another embodiment, the one touch window open/close feature of the vehicle may be programmed to operate in a certain manner based on the geo-location of the vehicle. In one embodiment, a specific operation of the one touch window open/close feature may be associated with a specific location. For instance, if the vehicle determines that the driver frequently passes through a specific check point and lowers one or more specific windows at the check point, the vehicle may use machine learning technology to learn this behavior. Once learned, whenever the driver approaches that specific checkpoint, the vehicle may automatically operate the one or more windows without the need for the driver to physically activate the one touch window open/close control.

In some embodiments, the user of the vehicle can activate the one touch window open/close feature via the HMI system of the vehicle, using voice commands, using gestures, etc. In one instance, the user may prescribe a specific value to be used for opening the window. (e.g., xx inches, or yy %). In some instances, activating the one touch window close or open feature on one window may result in the remaining windows of the vehicle opening partially. This amount can be programmed as per user desire. In other embodiments, activating the one touch window open/close feature may also result in fully closing any other open windows of the vehicle. In an embodiment, the user may use voice or gesture input to stop the window at a specific point within its travel in instances where the window is opening or closing. In some embodiments, the vehicle may use image recognition to determine whether to fully open all the windows of the vehicle. For example, if the vehicle determines that there are occupants in the vehicle and the temperature outside or inside of the vehicle is indicative that the vehicle needs ventilation, the vehicle may open all the windows of the vehicle fully or partially. In other instances, the extent of opening of each of the windows of the vehicle may be programmed by the user based on his/her desire. In some instances, if the vehicle has a moonroof or rear vent windows, they can also be programmed to use the one touch window open/close feature.

For vehicles, such as pick-up trucks, which have a bed and vent window in the rear of the passenger cabin, the vehicle may use one or more of its sensors, such as a camera, to determine whether there are any objects/cargo in the vehicle bed. The vehicle may also determine the type of object/cargo in the bed and based on that determine whether to open the rear vent window. For example, if the user is hauling mulch in the bed of his/her pick-up truck, the vehicle may identify the nature of the cargo and determine that it is not advisable to open the rear vent window. If the user attempts to open that rear vent window, the vehicle may provide an alert to the user and suggest keeping that rear vent window closed to avoid the mulch from entering the passenger cabin and/or the odor of the mulch from permeating within the passenger cabin.

In some embodiments, the vehicle may be programmed to learn certain behaviors or events and specific functionality can be assigned to the one touch window open/close control based on the behavior or event. A machine learning model may be programmed (e.g., into the memory 204) by providing the various behavioral aspects of the user along with vehicle related data such as speed, location, status of the various components of the vehicle, etc. to generate a model specific to the user. In operation, the model may analyze the current conditions and determine an appropriate action to take. For example, consider that the user of the vehicle always lowers the driver-side window when ordering a meal at a drive-through establishment. The user stops the vehicle at a first specific location in the drive-through path where a menu of items is posted. The vehicle may learn this behavior, capture images of the location and associate that with the window being opened completely. The next time the vehicle is at the location and detects presence of the menu based on images captured, the vehicle can conclude that the user is about to order from the list of menu items and automatically lower the driver side window so that the user can communicate with the order taking staff at the establishment. Many other such behaviors and locations can be associated with specific functioning of the one touch window open/close operation.

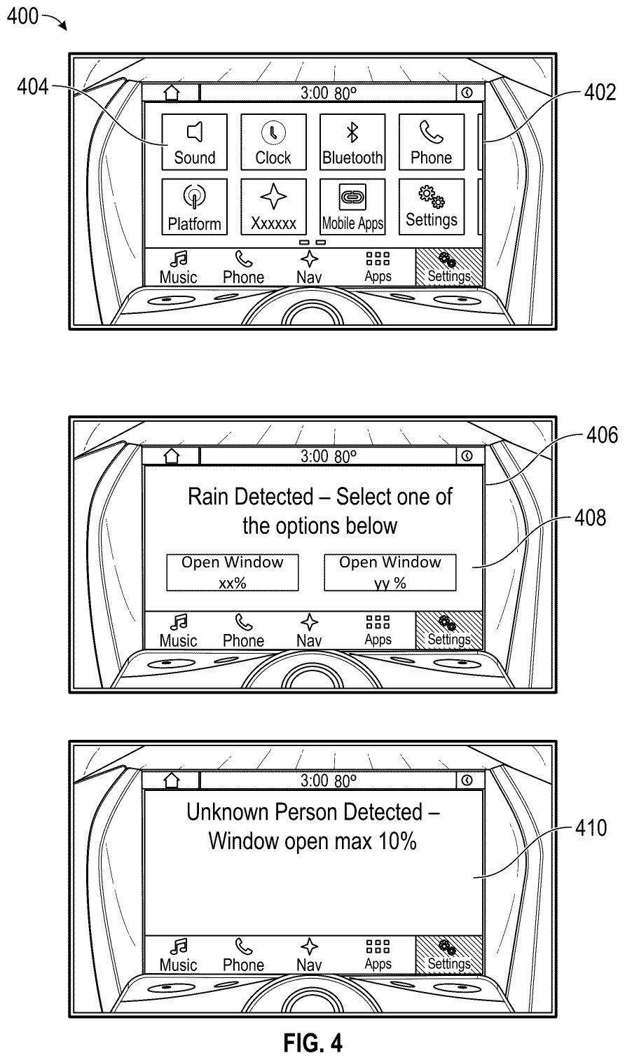

As noted above, the vehicle may present information about the one touch window open/close operation and/or provide the options for modifying the default operation of the one touch window open/close feature via the HMI system of the vehicle. FIG. 4 illustrates some user interface screens 400 that the vehicle may display according to an embodiment of the present disclosure. Screen 402 may be the “home” screen that displays several control inputs 404 associated with various features of the vehicle. In the instance where the vehicle detects activation of a one touch window open/close control input (e.g., a physical or a virtual button) and the vehicle also detects an environmental condition such as rain, the vehicle may display a screen 406 informing the user that the vehicle has detected rain. In addition, the vehicle may present options 408 for the user to modify the one touch window open/close operation. As illustrated, the modifications may include changing the window opening to a certain % value that may be more than 0 but less than 100. The user than has an option to either choose one of the options or dismiss both the options. If the user chooses one of the options 408, the vehicle may then modify the default operation of the one touch window open/close feature and instead open the associated window based on the selected option. If the driver dismisses or ignores the provided options, the vehicle may then proceed to perform the default operation of the one touch window open/close feature. In another embodiment, if the vehicle detects an unknown person in the vicinity of the vehicle and the user activates the one touch window open/close feature, the vehicle may present a screen 410. The screen 410 may include an alert informing the user that an unknown person has been detected and the window will be opened to a maximum of 10% of the full extent. It is to be noted that the screens 402, 406, and 410 are exemplary and other screens with different information may be displayed based on the specific status and operation of the vehicle.

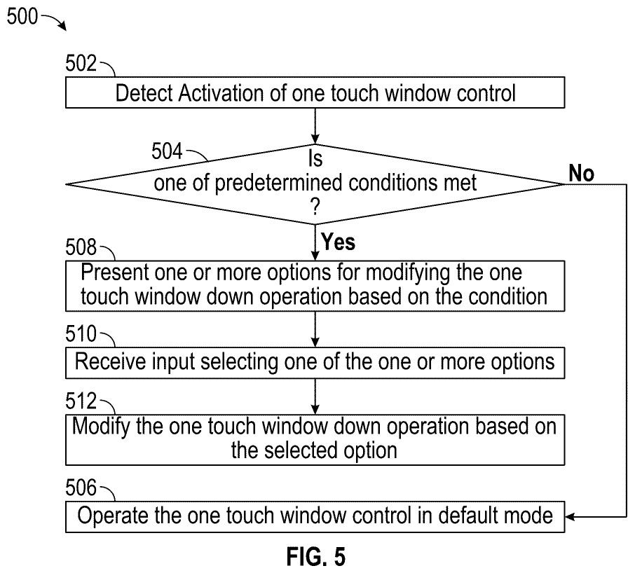

FIG. 5 is a flow diagram of a process 500 for operating a one touch window open/close feature of a vehicle according to an embodiment of the present disclosure. Process 500 can be performed by the vehicle 102 or by the vehicle 102 in conjunction with the server 104 of FIG. 1. At step 502, the vehicle may detect activation of a one touch window open/close control input of the vehicle. Based on detecting the activation of the one touch window open/close control input, the vehicle may determine whether one or more conditions have been met, at step 504. As explained above, the conditions may include several things such as environmental conditions, presence of people, location, presence of objects or structures, etc. In some embodiments, these conditions may be programmed into the vehicle. In other embodiments, the vehicle may infer the conditions. The vehicle may use data collected by one or more of its sensors to determine and/or infer the conditions. If the vehicle determines that none of the conditions are met, the vehicle may proceed to perform the default operation associated with the one touch window open/close feature at step 506. For example, the vehicle may fully open the window associated with the one touch window open/close feature.

If at step 506, the vehicle determines that one or more of the conditions are met, the vehicle may provide a list of one or more options to modify the operation of the one touch window open/close feature based on the condition(s) met (step 508). At step 510, the vehicle may receive input indicating selection of one of the one or more options provided in the earlier step. Based on the selected option, the vehicle may modify the operation of the one touch window open/close feature at step 512. Thereafter, the vehicle operates the associated window based on the modified operation.

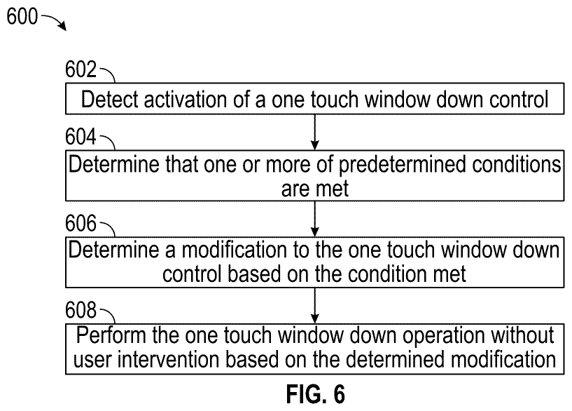

FIG. 6 is a flow chart for a process 600 according to an embodiment of the present disclosure. Process 600 illustrates a method for automatically modifying and performing a one touch window open/close operation without user intervention. At step 602, the vehicle may determine activation of the one touch window open/close feature (e.g., by pressing a button, voice command, gesture, etc.). At step 604, the vehicle may determine that one or more of the predetermined conditions are met (e.g., it is raining, vehicle is at a specific location, etc.). Based on condition(s) determined, the vehicle determines the modification to be made to the one touch window open/close operation at step 606. Then, at step 608, vehicle then proceeds to perform the one touch window open/close operation according to the modification determined at step 606 without any user intervention. In some embodiments, step 602 may be optional, and the vehicle may perform process 600 without any user intervention.

FIG. 7 depicts a block diagram of an example control server 700, (e.g., control server 104 of FIG. 1) upon which any of one or more techniques (e.g., methods) may be performed or which may perform the methods described above in conjunction with the vehicle 102, in accordance with one or more example embodiments of the present disclosure. In other embodiments, the server 700 may operate as a standalone device or may be connected (e.g., networked) to other servers. In a networked deployment, the server 700 may operate in the capacity of a server machine, a client machine, or both in server-client network environments. In an example, the server 700 may act as a peer server in peer-to-peer (P2P) (or other distributed) network environments. The server 700 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The server 700 may further include a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The server 700 may additionally include a storage device (i.e., drive unit) 716, a network interface device/transceiver 720 coupled to antenna(s), and one or more sensors 728, such as a global positioning system (GPS) sensor, a compass, an accelerometer, or other sensor. The server 700 may include an output controller 734, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 716 may include a machine readable medium 722 on which is stored one or more sets of data structures or instructions (e.g., software) embodying or utilized by any one or more of the techniques or functions described herein. The instructions may also reside, completely or at least partially, within the main memory 704, within the static memory 706, or within the hardware processor 702 during execution thereof by the server 700. In an example, one or any combination of the hardware processor 702, the main memory 704, the static memory 706, or the storage device 716 may constitute machine-readable media.

While the machine-readable medium 722 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the server 700 and that cause the server 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 700 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner manual and safety guidelines. In addition, any action taken by the vehicle owner/driver based on recommendations or notifications provided by the vehicle should comply with all the rules specific to the location and operation of the vehicle (e.g., Federal, state, country, city, etc.). The recommendation or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
detecting, by a vehicle, activation of a one touch window open/close feature of the vehicle;
detecting, by the vehicle, that one or more conditions associated with the one touch window open/close feature are met;
providing, by the vehicle, one or more options for modifying a default operation of the one touch window open/close feature;
receiving, by the vehicle, an input indicating selection of one of the one or more options;
modifying, by the vehicle, the default operation of the one touch window open/close feature to determine a modified operation; and
performing, by the vehicle, the one touch window open/close feature based on the modified operation.

2. The method of claim 1, wherein detecting the activation includes detecting activation of a physical control of the vehicle.

3. The method of claim 1, wherein the one or more conditions include one or more of:
presence of rain, snow, sleet, smoke, pollutants, or dust in an environment around the vehicle;
presence of unknown persons in a vicinity of the vehicle;
vehicle being at a specific location;
presence of a specific structure or object in the vicinity of the vehicle;
ambient temperature of the environment meeting a threshold temperature; or
an activity being performed by a user of the vehicle.

4. The method of claim 1, wherein receiving the input includes receiving a voice command or a gesture from a user of the vehicle.

5. The method of claim 1, wherein providing the one or more options including displaying the one or more options on a display of the vehicle.

6. The method of claim 1, wherein the modified operation is associated with a first window of the vehicle, the method further comprising:
performing, by the vehicle, a window open/close operation for a second window of the vehicle concurrently with the modified operation, wherein the window open/close operation is different than the modified operation.

7. The method of claim 1, wherein modifying the default operation further comprising:
determining, by the vehicle, that a first condition from the one or more conditions is met; and
determining, by the vehicle, a first modified operation associated with the first condition, wherein the first modified operation includes opening an associated window to less than 100% of a value defined by the default operation.

8. A vehicle comprising:
one or more processors;
one or more memory devices storing instructions and coupled to the one or more processors; and
one or more sensors coupled to the one or more processors, wherein the one or more processors are configured to execute the one or more instructions that cause the vehicle to:
detect activation of a one touch window open/close feature of the vehicle;
detect that one or more conditions associated with the one touch window open/close feature are met;
provide one or more options for modifying a default operation of the one touch window open/close feature;
receive an input indicating selection of one of the one or more options;
modify the default operation of the one touch window open/close feature to determine a modified operation; and
perform the one touch window open/close feature based on the modified operation.

9. The vehicle of claim 8, wherein to provide the one or more options the one or more processors are configured to display the one or more options on a display of the vehicle.

10. The vehicle of claim 8, wherein to detect the activation the one or more processors are configured to detect activation of a physical control of the vehicle.

11. The vehicle of claim 8, wherein the one or more conditions include one or more of:
presence of rain, snow, sleet, smoke, pollutants, or dust in an environment around the vehicle;
presence of unknown persons in a vicinity of the vehicle;
vehicle being at a specific location;
presence of a specific structure or object in the vicinity of the vehicle;
ambient temperature of the environment meeting a threshold temperature; or
an activity being performed by a user of the vehicle.

12. The vehicle of claim 8, wherein the one or more processors are configured to perform a window open/close operation for a second window of the vehicle concurrently with the modified operation, wherein the window open/close operation is different than the modified operation.

13. The vehicle of claim 8, wherein one or more processors are further configured to:
determine that a first condition from the one or more conditions is met; and
determine a first modified operation associated with the first condition, wherein the first modified operation includes opening an associated window to less than 100% of a value defined by the default operation.

14. The vehicle of claim 8, wherein to receive the input, the one or more processors is further configured to receive a voice input or a gesture input.

15. A method comprising:
detecting, by a vehicle at a first time, that the vehicle is at a first location;
determining, by the vehicle, one or more conditions associated with the first location;
determining, by the vehicle, a status of a window of the vehicle at the first location;
generating, by the vehicle, association information related to the first location, the one or more conditions and the status of the window; and
associating, by the vehicle, a one touch window open/close control operation with the association information.

16. The method of claim 15, further comprising:
determining, by the vehicle at a second time after the first time, that the vehicle is at the first location;
detecting, by the vehicle, activation of a control input associated with the window; and
executing, by the vehicle, the one touch window open/close control operation to place the window in the status.

17. The method of claim 15, wherein the status of the window corresponds to an extent to which the window is open or closed.

18. The method of claim 15, wherein determining the one or more conditions associated with the first location includes capturing audio, video, image and other data associated with the first location.

19. The method of claim 18, wherein determining, by the vehicle at a second time after the first time, that the vehicle is at the first location includes capturing data at the second time and comparing the data with the audio, video, image and the other data associated with the first location.

20. The method of claim 15, wherein the one or more conditions include one or more of:
geo-location data associated with the first location;
presence of specific objects and specific structures at the first location;
orientation of the vehicle when at the first location; and
speed of the vehicle when at the first location.
